(19) United States
(12) Patent Application Publication
(10) Pub. No.: US 2015/0254464 A1
(43) Pub. Date: Sep. 10, 2015

(54) METHOD AND SYSTEM TO PROVIDE CUSTOMIZABLE AND CONFIGURABLE LOCK SCREEN IN A USER DEVICE

(71) Applicant: Agreeya Mobility, Inc., CA, CA (US)

(72) Inventors: Aalap Shah, Pune (IN); Pankaj Thapa, CA, CA (US); Manish Dwivedi, Pune (IN); Rahul Tiwari, Pune (IN)

(21) Appl. No.: 14/641,018

(22) Filed: Mar. 6, 2015

Related U.S. Application Data
(60) Provisional application No. 61/949,628, filed on Mar. 7, 2014.

(51) Int. Cl. G06F 21/60; G06F 21/45

(52) U.S. Cl. CPC G06F 21/604; G06F 21/45

(57) ABSTRACT

The proposed embodiment provides a method and system to customize the keyguard and lock screen and provide custom ways of unlocking device/workspace. A password is configured dynamically in the electronic device in at least one format and accordingly a lock is triggered in the electronic device to enable screen lock. A customization application is selected through a predesigned interface for enabling a customized view to the lock mode of the screen. The lock customization application is selected to provide an access to one or more options for customizing the view of the lock screen.

### TECHNICAL FIELD

The embodiments of disclosure in general relates to customization of a lock screen. More particularly, the embodiments relates to the customization of the lock screen based on a predesigned interface.

### BACKGROUND

A keyguard of an electronic device is a module which is responsible for keyguarding an android device such as phone, tablet. The keyguard enables entry to the android device by showing a lock screen to a user. Commonly known lock screen in android comprises locking options such as None, Screen Slide, PIN, Pattern, Password and FaceUnlock.

The keyguard gets triggered through certain points. Few of them are, if user turns the device on from sleep, or if the device gets locked due to timeout of inactivity. Once a trigger point is fired Android system's Window Manager Service gets triggered. Window Manager Service delegates the task of performing necessary action to a Phone Window Manager. The Phone Window Manager delegates the locking action to Keyguard Service through Keyguard Service Delegate. Keyguard service instantiates Keyguard Host View to handle every action. Keyguard Host View is responsible for showing all the lock screen views which contain a widget view, actual unlock view and a user switcher view. The Keyguard Host View requests a Keyguard Security Model to choose unlock view for that user. Further, the Keyguard Security Model checks the lock screen policy from Device Policy Manager Service.

The Device Policy Manager Service maintains user's screen lock password quality. Further, the Keyguard Host View shows the corresponding unlock view from set of standard unlock views. Standard unlock views are None, Pattern, Password, PIN, Biometric, Account, SimPin and SimPuk.

It is evident that in existing implementation it is not possible to introduce a custom lock screen for the user device.

### SUMMARY

Accordingly, embodiments provide a system for providing customization of lock screen in an electronic device. The system comprises a processor and a memory coupled to the processor. The memory stores a plurality of modules to be executed by the processor. The plurality of modules are configured to dynamically configure a password in at least one format and trigger a lock mode on the screen of the electronic device by enabling the password so configured. The plurality of modules are further configured to select a customization application through a predesigned interface for providing a customized view to the lock mode of the screen. The customization application is selected to provide an access to one or more options for customizing the view of the lock screen.

Accordingly, embodiments also provide a method for providing customization of screen lock in an electronic device. The method comprises dynamically configuring a password in at least one format and triggering a lock mode on the screen of the electronic device by enabling the password so configured. The method also comprises selecting a customization application through a predesigned interface for providing a customized view to the lock mode of the screen. The customization application is selected to provide an access to one or more options for customizing the view of the lock screen.

### BRIEF DESCRIPTION OF FIGURES

This embodiment is illustrated in the accompanying drawings, throughout which like reference letters indicate corresponding parts in the various figures. The embodiments herein will be better understood from the following description with reference to the drawings, in which:

FIG. 1 is a network implementation of a system for providing a customizable lock screen in a user device, according to embodiments as disclosed herein;

FIG. 2 is illustrates details of modules in the system for providing a customizable lock screen in a user device, according to embodiments as disclosed herein;

FIG. 3 in an example embodiment to provide customization of lock screen, according to embodiments as disclosed herein;

FIG. 4 illustrates a flow chart of method to provide a customizable lock screen in a user device, according to embodiments as disclosed herein; and

FIG. 5 illustrates an example of class extension and user interfaces in the electronic device, according to embodiments as disclosed herein.

### DETAILED DESCRIPTION OF EMBODIMENT

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

A method and system to provide customization of lock screen and keyguard in an electronic device is described. A password is dynamically configured based on which a lock mode is triggered on a screen of electronic device. Quality of password is checked and accordingly a view customization application is selected through a predesigned interface. The selection of customization application provides a customized view to the lock mode of the screen. The locking screen is further selected to provide an access to one or more options for customizing the view of the lock screen.

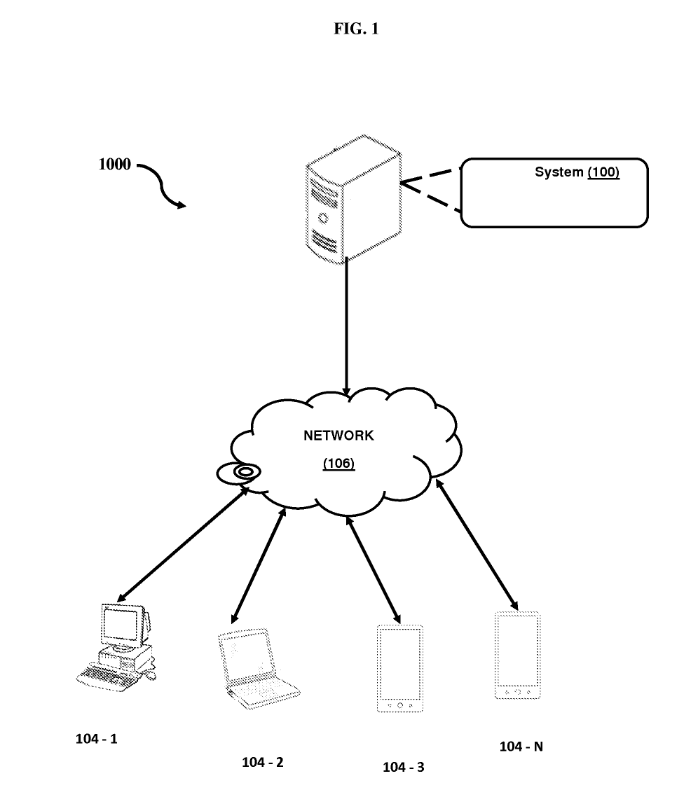

Referring to FIG. 1, a network implementation 1000 of the system 100 is shown. Although the present subject matter is explained considering that the system 100 may also be implemented as an application (to execute a set of instructions) on a server, it may be understood that the system 100 may also be implemented in a variety of computing systems, such as a laptop computer, a desktop computer, a notebook, a workstation, a server, a network server, an electronic device and the like. In one implementation, the system 100 may be implemented in a cloud-based environment. It may be understood that the system 100 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 100 through a network 106.

In one implementation, the network 106 may be a wireless network, a wired network or a combination thereof. The network 106 can be implemented as one of the different types of networks, such as intranet, local area network (LAN), wide area network (WAN), the internet, and the like.

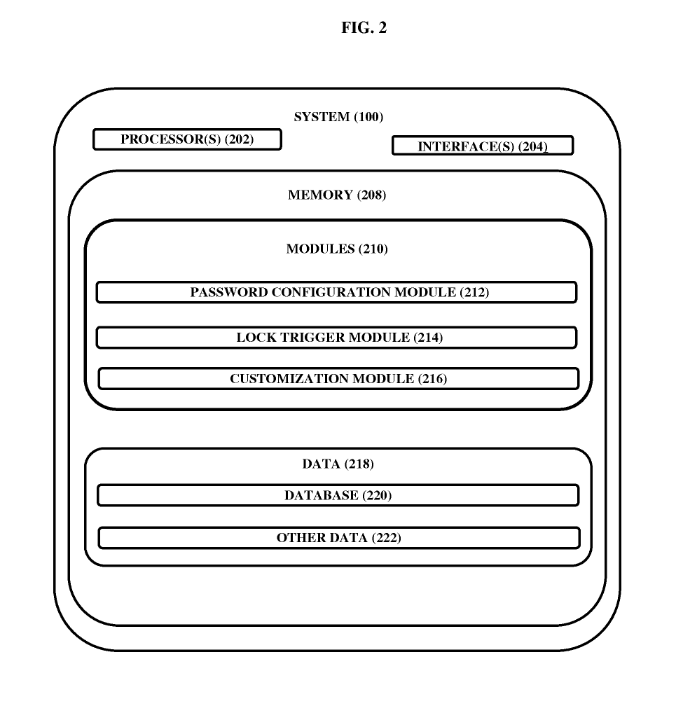

Referring to FIG. 2, the system 100 is illustrated in accordance with an embodiment of the present subject matter. In one embodiment, the system 100 may include at least one processor 202, an input/output (I/O) interface 204 (herein a configurable user interface), a memory 208. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 208.

The I/O interface 204 may include a variety of software and hardware interfaces, for example, a web interface, a graphical user interface, and the like. The I/O interface 204 may allow the system 100 to interact with a user directly or through the client devices 104. Further, the I/O interface 204 may enable the system 100 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The modules 210 include routines, programs, objects, components, data structures, etc., which perform particular tasks, functions or implement particular abstract data types. In one implementation, the modules 210 may include a password configuration module 212, a lock trigger module 214, and a customization module 216. The modules 210 may include programs or coded instructions that supplement applications and functions of the system 100.

The data 218, amongst other things, serves as a repository for storing data processed, received, and generated by one or more of the modules 210. The data 218 may also include a database 220, and other data 224. The other data 224 may include data generated as a result of the execution of one or more modules 210.

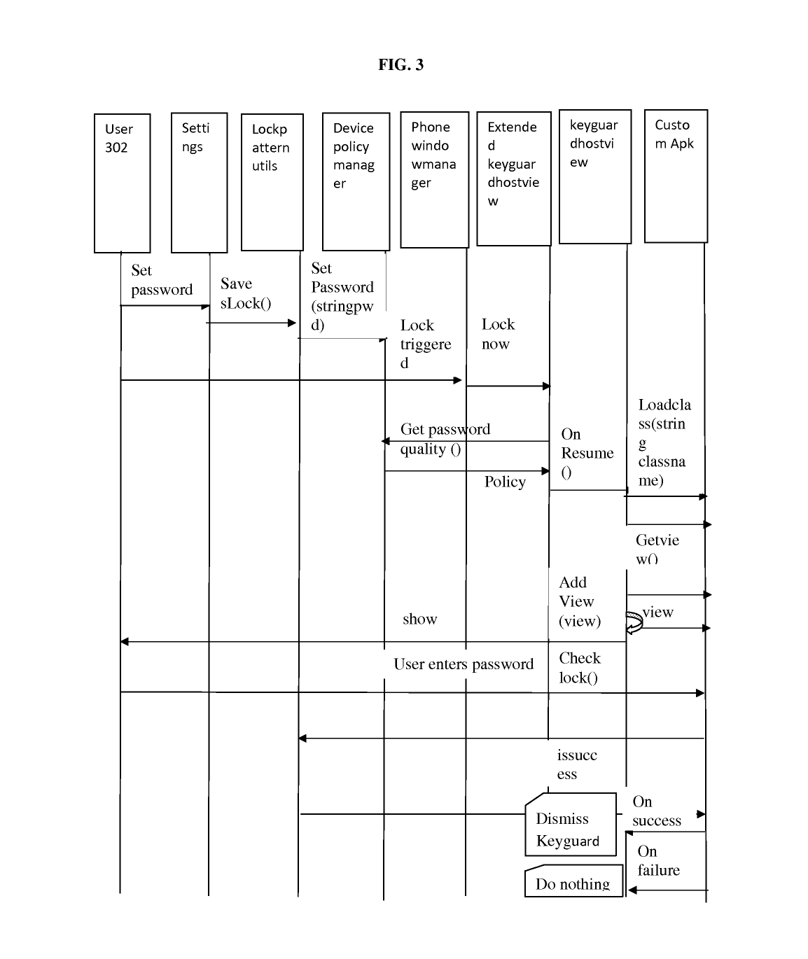

In accordance with an embodiment, referring to FIG. 3, customization of the lock screen and keyguard is shown. In an example, an android based keyguard may comprise one or more screen lock options. The one or more screen lock options (one or more lock formats or password formats) may comprise at least one of a no screen lock, pattern screen lock, screen swipe lock and a pin number screen lock. A user may select the one or more lock options to lock the screen and keyguard. The screen lock shows a limited view of the electronic device to the user and the user is not allowed to customize the view. In an example, the user is not allowed to change a background when the device is in a screen lock mode.

The password configuration module 212 allows an admin to dynamically configure and preset the password of the electronic device. The dynamic configuration of the password creates a new option in one or more lock options of the electronic device. In an example, the password may be termed as “dynamically configured password”. If the admin enables the “dynamic configured password” in the electronic device, the user may not change the password to any other lock option from the one or more lock options.

In an embodiment, examples of electronic device may comprise at least one of an android phone, and an android tablet.

The password may be configured remotely. The password may be set through a custom APK. First time, the “dynamic configured password” may be configured from the electronic device.

In an example embodiment, the “dynamically configured password” may be configured by the password configuration module 212 through a google APK, a facebook APK, an active directory APK, or any other APK. The customAPK may be installed in the electronic device and may be used by the password configuration module 212 to dynamically configure the password. The password configuration module 212 also supports a deletion of the custom APK and an installation of the custom APK if the user changes the services, for example from windows to google, then the password configuration module 212 may delete the active directory APK and may install the google APK and may enable the login into the electronic device.

In an embodiment, the “dynamically configured password” may be stored within the electronic device or in a cloud server. For example, when password is configured by using the face book APK, the “dynamically configured password” may be stored at the face book server. The “dynamically configured password” may integrate the electronic device with a backend server of an enterprise for storing emails or for documentation of services.

Still referring to FIG. 3, a user 302 sets the password and as per the setting and lock pattern of the electronic device, the password is saved. The lock pattern provides the option of “dynamically configured password”. The Device policy manager sets the password based on the option of the “dynamically configured password” (so configured by the password configuration module 212) and the lock is triggered by the lock trigger module 214. When the password is set remotely, the device policy manager also checks a quality of the password. The device policy manager checks if the password is a default password or the “dynamically configured password”.

When the device policy manager confirms that the password is “dynamically configured password”, the phone window manager through the customization module 216, selects a customization application through the custom APK. The custom APK is plugin and writes a customizable lock interface (predesigned interface) into the electronic device for enabling a customized view in the lock screen to the lock mode of screen. The custom APK loads class to already existing class (for example, keyguard host view class) of the electronic device. The custom APK may extend the class and may implement the tasks to be performed by the lock customization application. The tasks may include get view, reset etc.

The selection of the lock customization application through the customization module 216 provides an access to one or more options for customizing the view of the lock screen of the electronic device. The customization application also customizes view of the keyguard of the electronic device. The customization application also checks a correctness of the password configured by the admin.

The custom APK (custom keyguard APK) implements APIs to change the view of the electronic device to custom view and APIs to refresh the view. Custom view implements API to be notified for successful/unscuccessful unlock attempts from Custom Keyguard APK. In an embodiment, the communication between the custom view and the Custom Keyguard APK is using reflection. The custom view loads the custom Keyguard APK's published class. Further, the Keyguard may be configurable for using custom package and class.

The keyguard host view provides a view of one or more options over the customized lock interface in runtime. The one or more options on success of customization of the screen lock, allows the user to add view, change wall paper, lock/unlock the electronic device. The one or more options may be accessed by the user through one or more icons on the user interface of the electronic device.

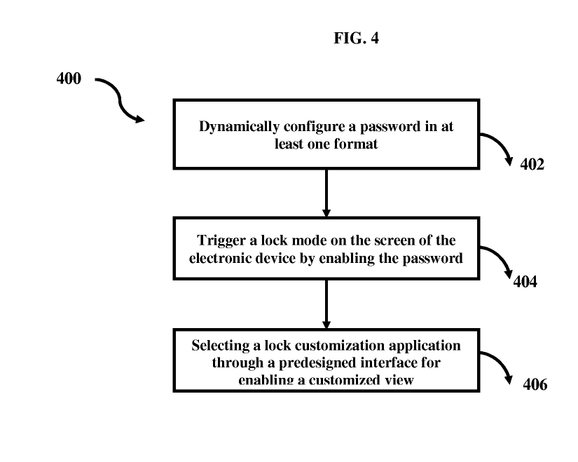

In accordance with an embodiment, referring to FIG. 4, a method 400 for providing customization of lock screen in an electronic device is described. In an embodiment, the method 400 may be performed by the system 100.

At step 402, the method provides a dynamic configuration of a password in at least one format. In an embodiment, the password is configured by the password configuration module 212.

At step 404, the method 400 provides atrigger of a lock mode on the screen of the electronic device by enabling the password so configured. In an embodiment, the lock is triggered by the lock trigger module 214.

At step 406, the method 400 provides a selection of a lock customization application through a predesigned interface for enabling a customized view to the lock mode of the screen. The lock customization application is selected to provide an access to one or more options for customizing the view of the lock screen. In an embodiment, the customization module 216 provides the selection of the customization application.

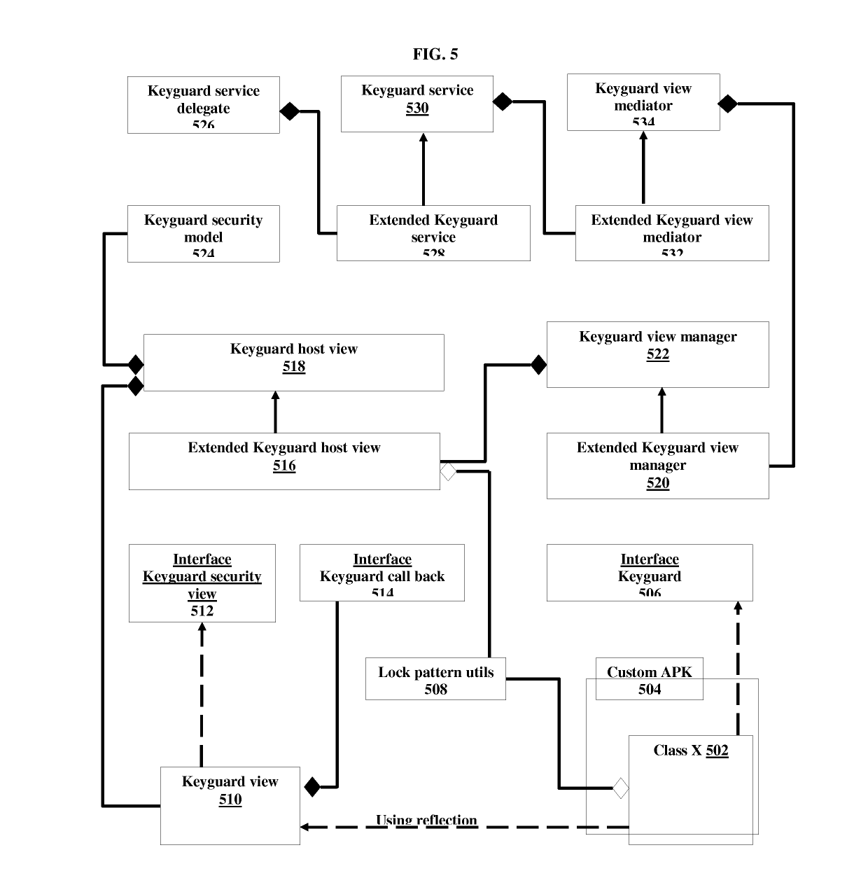

In an example embodiment, referring to FIG. 5, a class extension of android class to customize the lock screen is shown. Android class in general is known to a person ordinarily skilled in the art and the embodiment of the description provides an extension to the android class to provide customization of the lock screen. Class x 502 supports custom APK 504 for implementing interface keyguard 506. The custom APK 504 may use lock pattern utils 508 for configuring the password. The android class comprises a keyguard view 510 and an interface keyguard security view 512.

Interface keyguard call back 514 checks if the password entered by the user is correct or not. Extended keyguard host view 516 is a class extension to a keyguard host view 518. Extended keyguard view manager 520 is a class extension to keyguard view manager 522. The android model comprises keyguard security model 524 and keyguard service delegate 526. Extended keyguard service 528 is a class extension to keyguard service 530. Extended keyguard view mediator 532 is a class extension to keyguard view mediator 534.

The embodiments disclosed herein can be implemented through at least one software program running on at least one hardware device and performing network management functions to control the elements. The elements shown in FIG. 1 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A system for providing customization of lock screen in an electronic device, the system comprising:
a processor;
a memory coupled to the processor, wherein the memory stores a plurality of modules to be executed by the processor, and wherein the plurality of modules are configured to:
dynamically configure a password in at least one format;
trigger a lock mode on the screen of the electronic device by enabling the password so configured; and
select a customization application through a predesigned interface for providing a customized view to the lock mode of the screen, wherein the customization application is selected to provide an access to one or more options for customizing the view of the lock screen.

2. The system as claimed in claim 1, wherein the dynamic configuration of password comprises password configuration through a custom APK installed in the electronic device.

3. The system as claimed in claim 1, wherein the at least one format of the password comprises at least one of a pattern password, a PIN number password, and a screen swipe.

4. The system as claimed in claim 1, wherein the plurality of modules are configured to select the locking interface through a custom keyguard APK.

5. The system as claimed in claim 1, wherein the plurality of modules are configured to store the password in at least one of a hardware chip in the electronic device and a cloud server.

6. The system as claimed in claim 1, wherein the electronic device comprises at least one of an android phone, and an android tablet.

7. The system as claimed in claim 1, wherein the one or more options comprises at least one of adding views, customizing views, and changing wallpapers.

8. The system as claimed in claim 1, wherein the plurality of modules are configured to provide an access of the one or more options by way of one or more icons.

9. A method for providing customization of screen lock in an electronic device, the method comprising:
dynamically configuring a password in at least one format;
triggering a lock mode on the screen of the electronic device by enabling the password so configured; and
selecting a customization application through a predesigned interface for providing a customized view to the lock mode of the screen, wherein the customization application is selected to provide an access to one or more options for customizing the view of the lock screen.

10. The method as claimed in claim 9, wherein the at least one format of the password comprises at least one of a pattern password, a PIN number password, and a screen swipe.

11. The method as claimed in claim 9, wherein the locking interface is selected through a custom keyguard APK.

12. The method as claimed in claim 9, wherein the one or more options comprises at least one of adding views, customizing views, and changing wallpapers.

13. The method as claimed in claim 9, wherein the one or more options are accessed by way of one or more icons.

14. A non-transitory computer readable medium carrying one or more sequences of instructions for causing a system to provide customization of screen lock in an electronic device, wherein execution of one or more sequences of instructions by one or more processors contained in the system causes the one or more processors to perform actions of:
dynamically configuring a password in at least one format;
triggering a lock mode on the screen of the electronic device by enabling the password so configured; and
selecting a customization application through a predesigned interface for providing a customized view to the lock mode of the screen, wherein the customization application is selected to provide an access to one or more options for customizing the view of the lock screen.
